(19) United States
(12) Patent Application Publication
(10) Pub. No.: US 2011/0176876 A1
(43) Pub. Date: Jul. 21, 2011

(54) METHOD AND SYSTEM FOR PUNCTUAL FASTENING A WATERPROOFING MEMBRANE TO HYDRAULIC WORKS

(76) Inventor: Alberto Scuero, Castel San Pietro (IT)

(21) Appl. No.: 13/062,362

(22) PCT Filed: Sep. 2, 2009
(86) PCT No.: PCT/EP09/06344

§ 371 Date: Apr. 1, 2011

(30) Foreign Application Priority Data
Sep. 11, 2008 (IT) MI2008A001624

(51) Int. Cl. E21D 21/00; F16B 13/04

(52) U.S. Cl. 405/259.1; 411/15

(57) ABSTRACT

A method and a system for punctual fastening a waterproofing and protective membrane (13) of plastic material, for protective and waterproofing surfaces (19) of hydraulic works (10), such as canals, tunnels, dams and the like. In relation to surface areas subjected to fluid and/or wind actions, the protective membrane (13) is fastened to the concrete structure (11) of the hydraulic work and/or to ground (37) by a system of punctual fastening devices (15, 16). Each fastening device (15, 16) comprises an anchoring member (23, 32, 36) to penetrate into the concrete structure (11) and/or into ground (12) along a wished depth, provided with a tie rod or fastening end portion (23′, 35, 40) partially protruding from the surface (10) to be covered, to which the protective membrane (13) is sealingly fastened and pressed against the surface area of the hydraulic structure and/or ground by locking means (25, 26, 27, 28, 29); the locking means are conformed to provide a wide annular contact surface area with the membrane (13), suitable to transmit forces and/or strains to the punctual fastening devices (15).

### BACKGROUND OF THE INVENTION

The present invention refers to waterproofing coverings for hydraulic works, such as canals, tunnels, dams and the like, by a waterproofing and protective membrane of synthetic resin material, or plastic material in general term, usually termed as “geomembrane”, and in particular refers to a method and to a punctual fastening system suitable to transmit to the same hydraulic work or ground the forces and strains acting onto the membrane caused by the flowing fluid.

According to another object of the invention, a method and a fastening system for a waterproofing protective membrane have been provided of simple construction and relatively low cost, compared to conventional fastening systems, and suitable to withstand and transmit to the hydraulic work structure and/or to ground, by the same punctual anti-anchoring system, the forces generated by fluid infiltration caused by accidental membrane breakages and/or by the wind action, without damaging the protective membrane and the punctual fastening points.

According to a further object of the invention, a punctual fastening system has been provided comprising a suitable protective and safety system along the upper edges of side walls of a canal or a general hydraulic work.

### BRIEF DESCRIPTION OF THE INVENTION

The above mentioned objects can be obtained by a punctual fastening method according to claim 1, and by a punctual fastening system according to claim 3.

In particular, according to a first solution of the invention, a method has been provided for fastening a waterproofing protective membrane of plastic material onto a surface area to be covered of a hydraulic structure by mechanical fastening devices, characterized by the steps of:
providing a plurality of punctual fastening devices each comprising an anchoring portion conformed to penetrate into the hydraulic work and/or the underlying ground, and a membrane fastening portion extending from the anchoring portion of the fastening device;
causing the anchoring portion to penetrate into the structure of the hydraulic work and/or into ground, with the membrane fastening portion extending outside, said fastening devices defining a plurality of punctual anchoring positions for the protective membrane;
laying down the protective membrane onto the surface area to be covered, with the membrane fastening portion of the fastening devices extending through respective holes in the membrane;
positioning annular seals and locking plates conformed to provide an extensive annular contact surface area on at least one side of the membrane; and
anchoring the membrane to the punctual fastening devices by sealingly pressing the same membrane against the surface area to be covered, in a stretched condition to transmit and distribute any force and/or strain acting on the membrane to the individual punctual fastening devices.

According to the invention a fastening system has been provided for fastening a waterproofing protective membrane of plastic material, suitable for covering surface areas of hydraulic works by the above mentioned method, characterized by:
a plurality of punctual fastening devices arranged on a surface area of the hydraulic structure to be covered;
each punctual fastening device comprising an anchoring member conformed to penetrate into the concrete structure of the hydraulic work and/or into the ground, and a membrane fastening portion extending from said anchoring member;
sealing means engageable with the membrane fastening portion of the locking members, conformed and positioned to provide a frictional and sealing annular contact area on at least one side of the membrane, and compression of the same membrane against the surface area of the hydraulic structure.

### BRIEF DESCRIPTION OF FIGURES

The above mentioned and other features of the punctual anchoring method and system shall be more clearly explained by the following description relating to some examples, with reference to the drawings in which:

FIG. 1 is a cross sectional view of a canal, in which the protective membrane is fastened by a punctual fastening system according to the invention;

FIG. 2 is a top view of a canal length of FIG. 1;

FIG. 3 shows, as an example, a first punctual fastening device of a membrane along the canal upper edges;

FIG. 4 shows a second punctual fastening device, along the canal bank sides;

FIG. 5 shows a third embodiment of the punctual fastening device;

FIG. 6 shows a fourth embodiment for fastening a membrane to the bottom ground of a canal.

### DETAILED DESCRIPTION OF THE INVENTION

As it is well-known, in the past various solutions have been used for fastening, by simple friction action, a protective membrane of plastic material against a surface area to be protected of a hydraulic work, for example a dam surface in contact with water; a fastening system of this type is described, e.g. in U.S. Pat. No. 5,143,480. Further EP-A-0775781 describes a canal protective system, in which sheets of synthetic material are fastened by simple pins driven into the concrete along the peripheral edges of a canal, and in which the protective membrane is kept adherent to the surface of the canal by the sole water pressure, providing ballasting means on the bottom side.

Other fastening devices are described e.g. in U.S. Pat. No. 4,129,007 and U.S. Pat. No. 4,915,542.

In the past these fastening systems have shown some problems caused by water infiltration under the protective membrane, owing to cuts and/or breakages caused in the same protective membrane; other breakage causes comprise the bulging at the membrane due to negative pressures generated by the wind action. In all cases there were caused dangerous breakages and possible tearings of the membrane in the anchoring positions, as said fastening systems suffer to efficiently transmit to the hydraulic work and/or to underlying ground the stresses caused by the water and/or wind force, without injuring the integrity of the protective membrane and the sealing action in the anchoring zones.

Further the complex structure of some previously used fastening systems, caused a difficult and anti-economical protective laying of the protective membrane due to necessity of operating with great and heavy machines and equipments.

During the laying on of a protective membrane of plastic material onto hydraulic works using conventional fastening systems, it must be further considered that, to project and install these systems in hydrostatic conditions, it is not necessary to consider the stresses of the protective membrane. Conversely in hydrodynamic applications, it is essential to establish a correct fastening system of the protective membrane, for keeping the better system performance also in case of damages occurred to the membrane.

The present invention is aimed to provide a method and a fastening system to solve the problems encountered in conventional fastening systems that were used until today, suitable for application in hydrostatic and hydrodynamic conditions of hydraulic works and for anchoring a protective membrane both to a concrete structure of an hydraulic work, and to the ground, assuring an appropriate distribution of forces and stresses acting onto the same protective membrane.

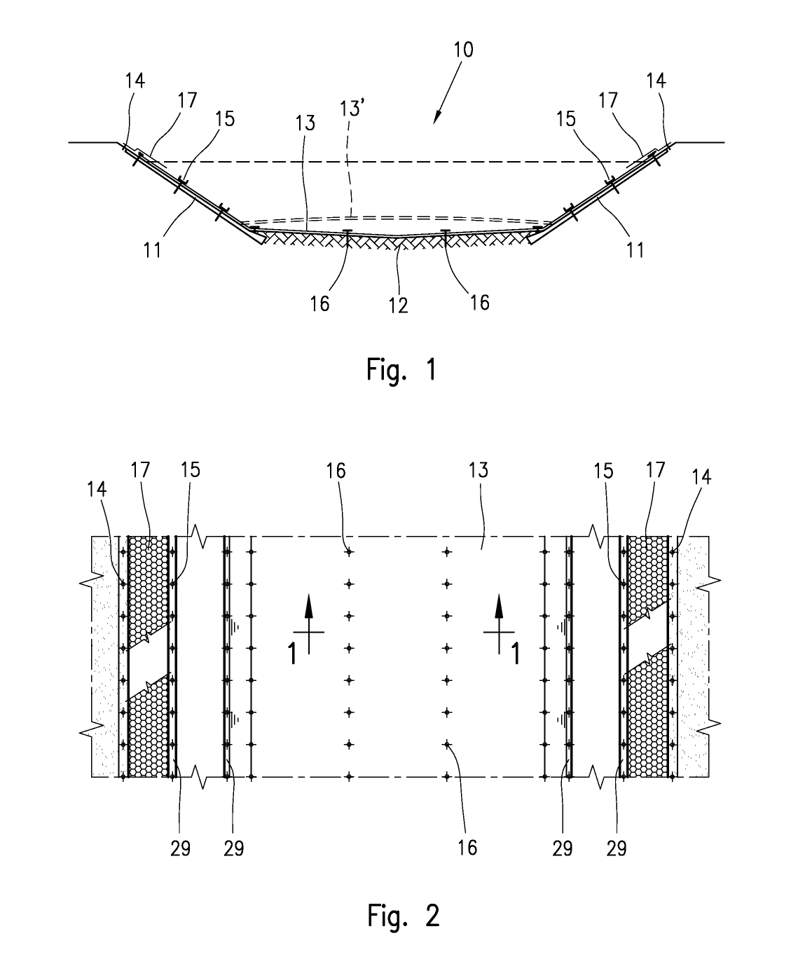

In particular, in the example of FIG. 1, it is shown a cross sectional view of a canal 10 having bank sides 11 of concrete, and a bottom 12 made by ground or by thin concrete plates.

The reference 13 in FIG. 1 relates to a protective membrane of plastic material both for the bank sides 11 and the bottom 12 of the canal, suitably fastened to withstand and transmit the forces and stresses acting onto the same protective membrane 13 to the various fastening points.

In general, a similar protective membrane 13 comprises an elastically flexible and extensible sheet of plastic material, commonly known as “geomembrane”, provided by connecting or welding many plastic sheets, e.g. of polyvinyl-chloride (PVC), or high-density polyethylene (HDPE), polypropylene (PP), or thermal polyolefins (TPO).

Depending on the characteristics of the hydraulic work and plastic material of protective membrane, and hydraulic conditions, it is necessary to make an appropriate selection of the fastening system that must be suitable to distribute and transmit the forces and/or the stresses acting on the protective membrane 13 to ground and/or to concrete structure of the work, and that, in the same time, be economical and easy to install.

On the basis of some tests, it was noted that good results can be obtained by using an anchoring system in established points, of punctual type, that is to say using special fastening devices positioned in points of a surface area to be covered, in detail on the lateral bank sides 11 and on the bottom 12 of the canal 10, shown in the example of FIGS. 1 and 2.

As it will be evident from the above mentioned figures, an integrated fastening system has been used comprising a plurality of punctual fastening devices both on the lateral bank sides of concrete, and on the bottom 12; the various fastening devices being aligned in the longitudinal canal direction of the canal, along parallel anchoring lines.

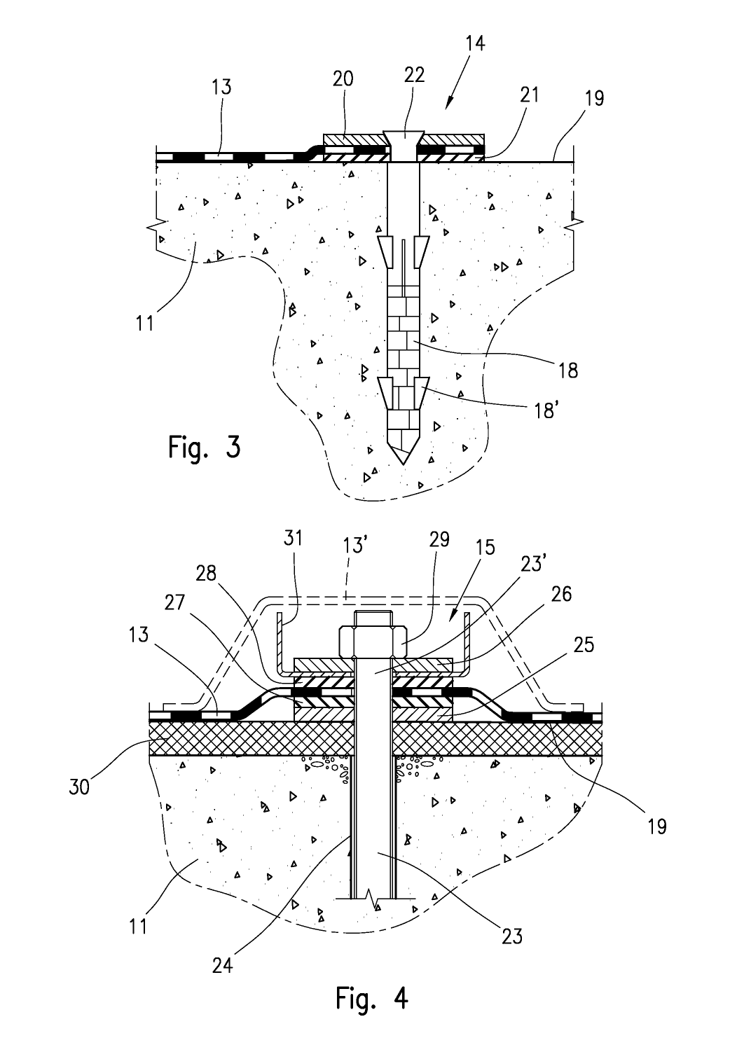

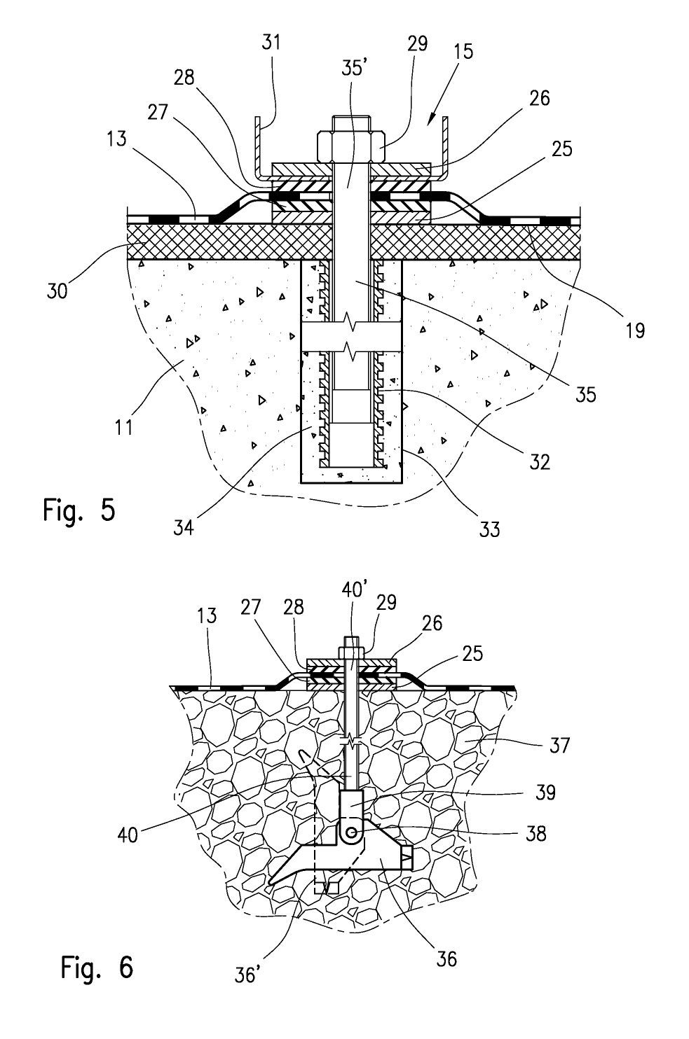

In better details the system comprises a number of punctual fastening devices 14 for the protective membrane 13, provided along the upper edges of lateral bank sides 11 of canal, e.g. of the type shown in FIG. 3. Further the system comprises two or more sets of punctual fastening devices 15 distributed along the two canal bank sides, e.g. of the type shown in FIG. 4 or 5, and one or more sets of punctual fastening devices 16 suitably distributed on the canal bottom 12.

In the case shown in FIGS. 1 e 2, while the punctual fastening devices 14 e 15 are conformed and arranged to transmit the forces directly to the concrete bank sides 11 of the canal, in the case of the canal bottom 12, as shown in the example of FIG. 6, the punctual fastening devices 16 are conformed and arranged to transmit directly the forces to underlying ground.

The FIGS. 1 and 2 show further the presence of a safety metallic grid 17 having wide meshes, fastened along the upper edges; suitable counterweights, not shown, may be arranged along the lower edge of the grid 17, that cooperates to hold down the protective membrane 13 and provide a suitable safety means to which a person accidentally fallen in the canal can grip for reascending and preventing to be dragged by the water flow.

Further the FIG. 1 shows that in the case of breakage of the waterproofing and protective membrane 13, e.g. in the case of a cross cut along the line 1-1 in FIG. 2, or a cut oriented in a different manner, the pressure of the water that infiltrates under the membrane will tend to bulge the same membrane, as schematically shown by the reference number 13′, in FIG. 1, applying forces oriented in different directions that will tend to further tear and break the membrane onto some punctual anchoring devices 15 and/or 16.

According to the present invention, the punctual fastening devices 15 and 16 are conformed for satisfying specifical exigencies:
a first exigency of guaranteeing a good hydraulic sealing the fastening points of the membrane; and
a second exigency of withstanding to the stress forces, suitably distributing them onto the hydraulic work structure and/or onto the underlying ground.

What above said can be obtained conforming the fastening devices 15 e 16 to provide wide annular contact and sealing surface areas around the holes in the membrane 13 crossed by the fastening devices; further this can be obtained conforming or using the punctual fastening devices suitable to offer a sure anchoring to the hydraulic work structure, or a deep anchoring to ground.

Depending on mechanical characteristics of the membrane 13, its thickness and hydraulic flow rate, it is as much important to define a correct layout and reciprocal space between the various fastening devices. For example, canals waterproofed by protective membranes 13 having a minimum thickness of ab. 2 mm, with low modulus of elasticity lower than 25 N/mm² both in transversal and longitudinal directions, according to standard DIN EN ISO 527-1/3, and with a water flow having a speed of ab. 6 m/sec or lower, good results have been obtained by providing spaces between the fastening devices with a length comprised between 0.5 and 3 m.

Some types of fastening devices are shown in the examples of figures from 3 to 6; in particular the example in FIG. 3 concerns the fastening devices 14 used on the lateral edges of membranes 13. The device 14 includes a stud 18 having expandable wings 18′ anchored in a bored in the concrete bank side 11, eventually extending also into the underlying ground according to the required anchoring force. In this case the edge of membrane 13 is fastened and sealingly pushed against the surface 19 of the canal bank side 11, or more in general against a hydraulic work surface area, using locking means provided by a flat section bar 20, an annular sealing gasket 21 positioned between the edge of the membrane 13 and the underlying surface 19, and a bolt 22 screwed into the upper end of the anchoring stud 18. As shown in the enlarged detail in FIG. 3, the dimensions of the flat section bar 20 and the gasket 21 are suitable to supply a wide annular sealing surface area around the hole 13 for example three or more time larger than the hole 13 of the same membrane to apply a strong fictional force on one or both sides of the same membrane 13.

The FIG. 4 shows an enlarged detail of a second fastening device 15 of the chemical type, suitable for anchoring the membrane to a concrete surface of a hydraulic work; the device, in a well-known manner, comprises an anchoring element in the form of a stud 23 that extends into a sheath 24 holding a chemically setting resin mixture in a hole made in the concrete wall 11.

The stud 23, in addition to represent the anchoring element, has its upper part 23′ extending upward to allow a sealing fastening of the membrane 13. In this case the membrane 13 is sealingly fastened by a sealing device comprising a lower metal plate 25, an upper metal plate 26 and two annular gaskets 27, 28 on opposite sides of membrane 13; an eventual metal bar 31 having a U-shaped section, longitudinally extends and is fastened between anchoring devices 15 aligned in the longitudinal direction of the canal, for distributing the stresses and forces to two or more contiguous fastening devices. The assembly of locking plates, of annular gaskets and of metallic section bar is sealingly pressed against a water draining layer 30 of textile material, arranged between the membrane 13 and the surface 19, by a nut 29 screwed onto the protruding end 23′ of anchoring stud 23.

Also in this case the assembly of locking plates 25, 26 and gaskets 27 and 28 is suitable to supply a wide annular contact surface on both sides of the membrane 13 appropriate to assure the necessary watertight sealing, fiction force and mechanical locking action by the stud 23, suitable to transmit the forces applied to the membrane 13, without damaging this later, to the whole fastening devices.

Finally FIG. 4 shows the possibility to cover the various fastening devices, aligned along the canal with a protective band 13′ of the same plastic material of membrane 13, welded on the lateral edges, bridging the metallic section bar 31.

The FIG. 5 shows a further possible embodiment of the anchoring device 15, always suitable to be anchored to a concrete wall of hydraulic work. The device 15 in FIG. 5 comprises a tubular element 32 having external fins, fitted into a hole 33 larger than the element 32; the finned tubular element 32 is then embedded into a cement mortar 34, that can be poured or injected through the same tubular element 32, or by another method.

Also in this case a stud 35 screwed into the tubular element 32, provides an anchoring part 35 which extends from the tubular element 32 to the outside for anchoring the membrane 13; in this case the anchoring part 35′ comprises by a bolt screwed into the tubular element 32. In FIG. 5 the same reference numbers of FIG. 4 have been used to show similar or equivalent parts.

On the contrary FIG. 6 shows the use of a fastening device for a deep anchoring directly into the ground, when the surface 29 of ground is made by gravel, or when the concrete thickness is extremely reduced. In the case of FIG. 6, the fastening device comprises a shaped anchoring member 36 hinged to a tie-rod 40 and conformed for being pushed and to penetrate until a wished depth, into the ground 37; the anchoring member 36 is hinged in 38 to a fork member 39 at the fore end of the tie-rod 40 the rear end 40′ of which extends upwardly through a hole in the protective membrane 13; the tie-rod 40 can be provided by a metal rod or by a cable. Again, the sealing components of the anchoring device provided to sealingly lock the membrane 13 have been indicated by the same reference numbers of preceding figures.

According to the punctual anchoring method and system conforming to the present invention, in the positions of the various fastening points of membrane 13 it is provided a punctual fastening device 15 and/or 16, whose anchoring members 23, 32 or 36 are fitted into the concrete wall and/or in the ground for a prefixed depth, with a membrane fastening part 23′, 35 or 40′ partially protruding outside. The protective membrane 13, provided with suitable through holes for the fastening element, is laid down onto the surface to be covered, after having positioned the plates 25 and the lower gaskets 27. Then the upper gaskets 28, the plates 26 and the metallic section bars 31 are positioned, locking the whole assembly by the nut 29. In this manner, the membrane 13 is sealingly locked on the two sides between the contact surfaces of gaskets locked between the two plates; furthermore the membrane 13 is elastically stretched and pushed against the surface 19 of ground and/or of concrete wall; in this manner it is possible to distribute and transmit to the ground and/or hydraulic structure all the forces and stresses acting onto the membrane by means of the various punctual fastening devices.

It shall be understood that what has been described and shown in annexed drawings has been provided for illustrative purpose only of some preferred embodiments and that the punctual fastening system according to the present invention can be applied in any manner and differently used for fastening a protective of any hydraulic work, without departing from the claims

1-6. (canceled)

7. A method for fastening a waterproofing and protective membrane (13) of elastically and extensible sheets plastic material onto a bottom and/or side surface area (11, 12) of a hydraulic work (10) by a plurality of punctual fastening devices (14, 15, 16), each comprising an anchoring portion (18, 23, 32, 40) conformed to penetrate into the structure of the hydraulic work (11, 12) and/or an underlying ground, and an upper membrane fastening portion (22, 23′, 35′, 40); the method comprising the steps of:
causing the anchoring portion (18, 23, 35, 40) of the punctual fastening devices (14, 15, 16), to penetrate into the structure of the hydraulic work (11, 12) and/or into the ground (37), with the upper membrane fastening portion (22, 23′, 35′, 40) extending outside;
laying down the protective membrane (13) onto the surface area (11, 12) to be covered of the hydraulic work (10), with the membrane upper fastening portion (22, 23′, 35′, 40) of the fastening devices (14, 15, 16) extending through respective holes in the membrane (13);
providing annular seals (27, 28) and locking plates (25, 26) on at least one side of the membrane (13), conformed with an annular frictional surface;
anchoring the membrane (13) to the punctual fastening devices (14, 15, 16) by sealingly pressing the membrane (13) against the annular seals (27, 28) and the surface area (11, 12) to be covered of the hydraulic work;
characterized by the steps of
defining a plurality of punctual anchoring positions for the protective membrane (13); and
anchoring the membrane (13) at said anchoring positions, to the punctual fastening devices (14, 15, 16) along parallely extending anchoring lines by sealingly pressing the membrane (13) against the surface area (11, 12) to be covered of the hydraulic work in a stretched condition, distributing and transmitting any force and/or stress acting on the membrane (13), to the individual punctual fastening devices (14, 15, 16), to the hydraulic structure, and/or to the ground.

8. The method according to claim 7, characterized by connecting at least part of punctual fastening devices (14, 15, 16) with a section bar element (31).

9. A fastening system suitable for fastening a waterproofing and protective membrane (13) in elastically flexible and extensible sheets of plastic material onto a bottom and/or side surface area (11, 12) of hydraulic works (10), by the method of claim 7, characterized by comprising:
a plurality of punctual fastening devices (14, 15, 16) longitudinally arranged along parallely extending anchoring lines;
said punctual fastening devices (14, 15, 16) being selectable from fastening devices comprising, either taken individually or in combination:
an anchor stud (18) having expandable wings (18′);
a stud (23) extending into a sheath (24) comprising a settable chemical mixture;
a stud (35) screwable into a tubular element (32) having external fins embedded into a cement mortar (34);
a tie-rod (40) having a shaped anchoring member (36) hinged to the same tie-rod (40).

10. The fastening system according to claim 9, characterized by comprising a section bar element (31) connecting punctual fastening devices (15, 16) contiguously arranged on an anchoring line.

11. The fastening system according to claim 9, characterized by comprising a grid (17) fastened along at least part of a peripheral edge of the protective membrane (13).
